(19) United States
(12) Patent Application Publication
(10) Pub. No.: US 2002/0148843 A1
(43) Pub. Date: Oct. 17, 2002

(54) Bottle with multiple label panels

(76) Inventors: Xiao Ping Shen, Ypsilant, MI (US); Robert J. Johnson, South Lyon, MI (US)

Correspondence Address: Harness Dickey & Pierce PLC, P O Box 828, Bloomfield Hills, MI, 48303, US

(21) Appl. No.: 09/504,225

(22) Filed: Feb. 15, 2000

(51) Int. Cl. B65D 23/00; A47J 41/02; B65D 6/08; B65D 6/10

(52) U.S. Cl. 220/672

(57) ABSTRACT

A bottle is disclosed with a configuration allowing for multiple labeling options. Specifically, the sidewall of the bottle includes at least label boundaries, defined in the generally cylindrical portion thereof. These label boundaries further define at least two labeling options for the bottle.

### BACKGROUND OF THE INVENTION

1. Field of the Invention

This invention relates generally to a bottle configuration having multiple indented label panels suitable for attaching a variety of label sizes. The labels are generally a wrap-a-round variety or a stretchable sleeve variety. The bottle typically has a circular cross-sectional shape, but largely square, rectangular, oval or other cross-sectional shapes are practical. The invention is suited for bottles made of polyester materials, such as polyethylene terephthalate (PET), or other polymeric materials.

2. Description of the Prior Art

In the scheme of things, the bottle serves various purposes in today's market, particularly for products sold and delivered through “self-service” outlets. The bottle often plays an important role in product marketing and promotion. The bottle helps establish a product image and usually helps to differentiate the product from other similar products. The bottle often provides consumer convenience and ease of product use. Consequently, many different bottle shapes are evident in the marketplace.

However, the bottle itself is usually not a consumer product. Its primary purpose is to serve as a vessel necessary to hold, convey, and protect the product until used by the consumer. The consumer usually discards the bottle when finished. Consequently, a bottle, while interested in properly protecting and creating a positive product image, is also interested in a functional low cost bottle.

A bottle supplier can reduce cost by minimizing the amount of material used. Bottle functionality, while often specific to each application, involves careful detailing of bottle shape and structure, particularly when minimizing the amount of material used. Some shapes are more suitable than others for providing high structural functionality at a reduced weight.

Furthermore, the bottle supplier can reduce cost through standardization. Certain economies are available if the bottle manufacturer can supply the same functional bottle shape to several bottlers. Nonetheless, a standardized bottle shape sold to several bottlers makes marketplace differentiation more difficult for each bottler, particularly for a commodity product like bottled water.

Fortunately, the bottlers can also establish marketplace differentiation through bottle labeling. The colors, graphics, shape and size all play an important role. Unfortunately, bottle handling, at the bottling facility and at the consumer outlet, can scuff or otherwise damage the bottle label, distracting from product image. Consumers in a “self-serve” outlet will not likely select a bottle with a damaged label when a bottle without a damaged label is readily at hand.

The labeling area of the bottle can be recessed or indented. This indentation helps to protect the label, such as a wrap-a-round label, a sleeve label or other label, from damage caused during bottle handling. The wrap-a-round label is a flat sheet. When applied to the bottle, two ends of the wrap-a-round label overlap and attach to each other. The stretchable sleeve label is a tube. Applying the stretchable sleeve label is usually from above and from a direction corresponding to the neck finish. In the case where the stretchable sleeve label is used, the indentations help retain the label in its proper location minimizing slippage.

Before to this invention, an indentation provision was specific for a particular label size and position. For that bottle, no matter what label the bottlers applied, label size and position relative to other bottle features was constant. Label graphics, notwithstanding, products packaged in a standardized bottle shape with a standardized label size and position by several bottlers will tend to look the same to many “self-serve” shoppers making a quick choice decision.

The purpose of this invention is to provide a highly functional lightweight, standardized bottle shape for commodity products, such as bottled water. The bottle offers the bottlers the advantage of indented labeling surfaces that help to protect applied labels from damage, while allowing a selection of alternative label size and positions. This arrangement provides the bottlers the opportunity for better product differentiation with out resorting to more costly customized bottle configurations.

The bottle comprises a neck finish having an opening through which the filler typically fills product into the bottle and the consumer typically dispenses the product from the bottle. Depending from the neck finish is a bottle sidewall. Depending from the sidewall is a closed base. In most applications, this base supports the bottle while it rests on a suitable surface. The sidewall features at least three indented label boundaries. The bottlers can combine these boundaries to create at least two label area alternatives for either the wrap-a-round label or the stretchable sleeve label.

In the case of three boundaries, one of the boundaries is common for two alternatives. The other two boundaries create two alternative labeling areas. The larger of the two alternative labeling areas requires an applied label to cover and conceal one of the indented boundaries. To minimize “print-through,” depth of the concealed boundary indentation is often at a minimum. “Print-through” is a slight bulge or mark on the applied label at the point of the concealed boundary.

In another embodiment, the sidewall features four indented label boundaries. In this case, two of the boundaries are near the bottle neck-finish. The other two boundaries are near the bottle base. This arrangement offers the bottlers four labeling alternatives. Although the bottle shape is identical, the label alternatives have different size and/or position offering opportunities when combined with different label graphics to create a strikingly different look to the bottle.

Other embodiments include, five indented boundaries offering the bottlers six labeling alternatives and six indented boundaries offering nine labeling alternatives.

From the following description of the preferred embodiment, the appended claims, and the accompanying drawings, additional benefits and advantages of the present invention will become apparent to those skilled in the art to which the present invention relates.

### DESCRIPTION OF THE DRAWINGS

FIG. I is an elevational view of a bottle with multiple label panels;

FIG. 1a and 1b are enlarged views, each of a portion of the bottle shown in FIG. 1;

FIG. 2 is a top view of the bottle seen in FIG. 1; and

FIG. 3a, 3b, 3c, and 3d are elevational views of the bottle in FIG. 1 showing various label treatments.

### DESCRIPTION OF THE INVENTION

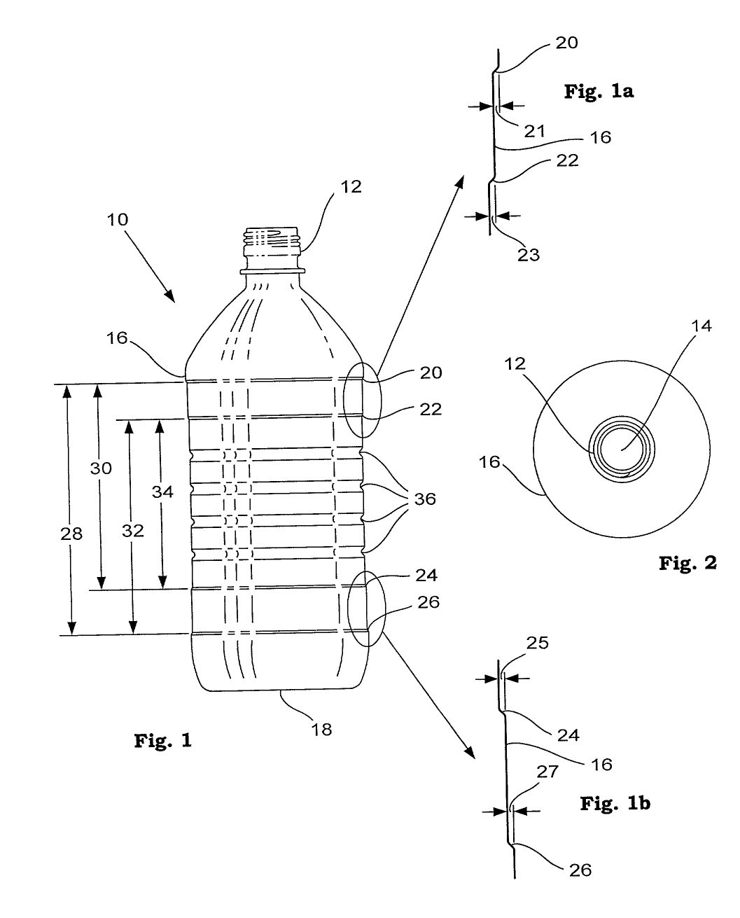

Referring now to the drawings, FIG. 1 illustrates a bottle 10 with a neck finish 12 for attachment of a closure (not illustrated) and having an opening 14 (FIG. 2), a sidewall 16, and a base 18. For purposes of this application, sidewall 16 is the entire length from the neck finish 12 to base 18. Grooves 36 are typical reinforcements to stiffen the sidewall 16.

Sidewall 16 features four label boundaries 20, 22, 24, and 26 defined by shoulders and forming four labeling areas or label panel options, a large label panel 28, a first intermediate label panel 30, a second intermediate label panel 32, and a small label panel 34.

As seen in FIG. 1a and 1b, each label boundary 20, 22, 24, and 26 steps a radial distance 21, 23, 25, and 27 respectively. For most bottle 10 configurations, the distances 21, 23, 25, and 27 are typically between 0.010 to 0.040. In other words, the radial distance between two adjacent portions of the labeling areas, as measured from a central longitudinal axis 29, is in the range of 0.01 and 0.04 inch, and preferably between 0.010 to 0.015 inch.

FIG. 2 is a top view clearly showing that bottle 10 is circular in nature. Circular bottles are typically lighter in weight for a given size and generally more suitable for applying a “wrap-a-round”0 or stretchable sleeve label; however, this invention is equally suitable for bottles with a substantially oval, square, or rectangular nature.

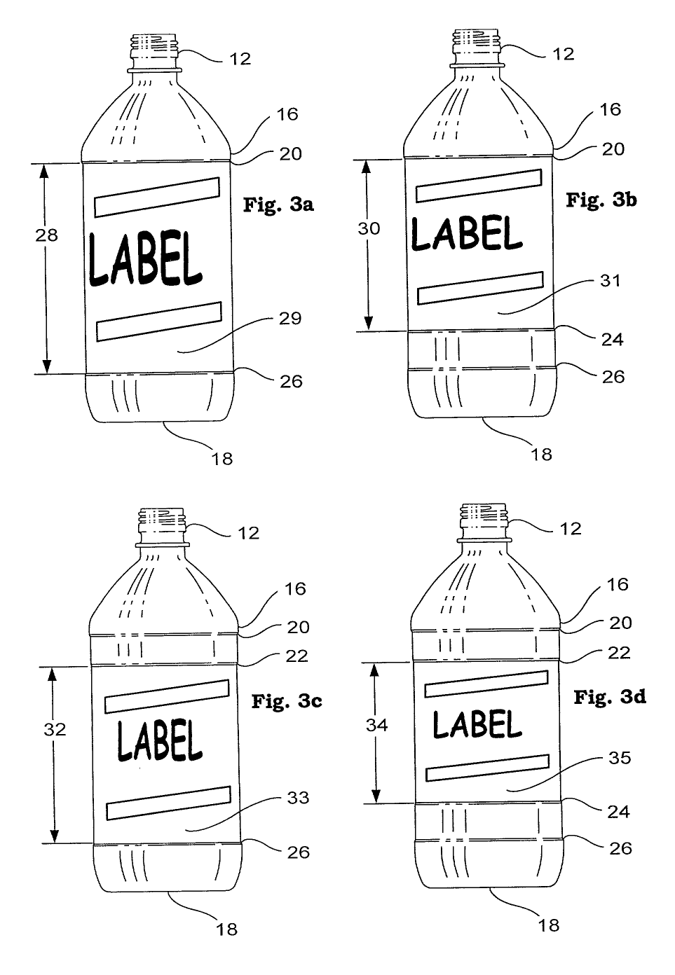

FIG. 3a, 3b, 3c, and 3d illustrate available label options. FIG. 3a shows a large label 29 sized between the label boundaries 20 and 26. The areas immediately above and below the label boundaries 20 and 26, respectively, define the maximum diameter of the bottle 10. The large label 29 when applied to the large label panel 28 conceals the label boundaries 22 and 24 shown in FIG. 1. Accordingly, the large label panel 28 defines a first effective diameter.

FIG. 3b shows a first intermediate label 31 sized between the label boundaries 20 and 24. The first intermediate label 31 when applied to the first intermediate label panel 30 conceals the label boundary 22 shown in FIG. 1. With the first intermediate label 31, the label boundary 26 remains visible. The first immediate label panel 30 defining another effective diameter being less than said first effective diameter. In calculating said second effective diameter, it may be considered as either the average between the two adjacent portions of the labeling areas or just the lesser of the two. This is also applicable to the second immediate label 33 and small label 35.

FIG. 3c shows a second intermediate label 33 sized between the label boundaries 22 and 26. The second intermediate label 33 when applied to the second intermediate label panel 32 will conceal the label boundary 24 shown in FIG. 1. With the second intermediate label 33, the label boundary 20 remains visible.

FIG. 3d shows a small label 35 sized between the label boundaries 22 and 24. The small label 35 when applied to the small label panel 34 will not conceal the other label boundaries. With the small label 35, the label boundaries 20 and 26 remain visible.

The label boundaries 20 and 26 indented the distance 21 and 27 respectively, effectively indents the large label panel 28, which helps to protect, the large label 29 from damage or minimizes slippage of the large label 29 from its proper position. The indentation of the large label panel 28 effectively indents the first intermediate label panel 30, second intermediate label panel 32, and small label panel 34 as well.

For a given bottle 10 configuration, the distance 21, 23, 25, and 27 can be identical. To provide an extra measure of label protection, the distance 21 and 27 can be slightly greater than the distance 23 and 25. Alternatively, reducing the distance 23 and 25 to a minimum needed to define the label boundary 22 and 24 helps to reduce a label “print-through,” not illustrated, of those boundaries concealed when the bottler applies the large label 29, first intermediate label 31, or second intermediate label 33 option to the bottle 10. The label “print-through” is a slight bulge or mark on the label surface at the location of the concealed label boundary.

Minimizing the distance 23 and 25 to a dimension of about 0.010 inch to minimize or eliminate “print-through” will not sacrifice label protection still effectively provided by the label boundaries 20 and 26. Label protection is in part a function of total indentation. In other words, the distance 21 of label boundary 20 enhances the label protection label boundary 22 provides. The label protection of boundary 22 is generally a sum of the distance 21 and 23. Likewise, the distance 27 of label boundary 26 enhances the label protection label boundary 24 provides.

The forgoing description illustrates the invention with four label boundaries providing four label options. Those skilled in the art will recognize that the invention applies equally to a configuration with three, five or six indented boundaries respectively providing three, six, or nine label options.

The inventor claims:

1. A container comprising:
a neck finish defining an opening into said container;
a base closing a bottom of said container;
a sidewall extending between said neck finish and said base; and
at least three label boundaries formed in said sidewall and defining at least two labeling options, said label boundaries being defined by a shoulder between two adjacent portions of said container, said two adjacent portions being located first and second distances from a central longitudinal axis defined through said container.

2. A container according to claim 1 wherein said shoulder defines a third distance between said two adjacent portions of generally between 0.01 inch to 0.04 inches.

3. A container according to claim 2 wherein said third distance is a radial distance.

4. A container according to claim 1 wherein said at least two labeling options have differing lengths measured along said central axis.

5. A container according to claim 1 wherein said at least two label boundaries extend substantially circumferentially about said container.

6. A container according to claim 1 wherein said at least two label options extend substantially circumferentially about said container.

7. A container according to claim 1 wherein said container includes four label boundaries defining at least four labeling options.

8. A container according to claim 7 wherein said least four label boundaries include a first label boundary, a second label boundary, a third label boundary and a fourth label boundary.

9. A container according to claim 8 wherein said first and fourth label boundaries cooperate to define a large label panel, said second and third label boundaries cooperate to define a small label panel, said first and third label boundaries cooperate to define a first intermediate label panel, and said second and fourth label boundaries cooperate to define a second intermediate label panel.

10. A container according to claim 9 wherein said large label panel has a label received therein, said large label being one of a wrap-a-round label and a stretchable sleeve label and said label extending over and covering said second and third label boundaries.

11. A container according to claim 9 wherein said first intermediate label panel has a label received therein, said label being one of a wrap-a-round label and a stretchable sleeve label and said first label extending over and covering said second label boundary.

12. A container according to claim 9 wherein said second intermediate label panel has a label received therein, said label being one of a wrap-a-round label and a stretchable sleeve label and said label extending over and covering said third label boundary.

13. A container according to claim 9 wherein said small label panel has a label received therein, said label being one of a wrap-a-round label and a stretchable sleeve label and said label extending around said container without covering said first and fourth label boundaries.

14. A bottle comprising:
a neck finish defining an opening into said bottle;
a base closing off a bottom of said bottle; and
a sidewall extending between said neck finish and said base, said sidewall having a first label area of a first effective diameter and a second label area of a second effective diameter, said first effective diameter being greater than said second effective diameter and being less than a maximum effective diameter of said bottle.

15. The bottle according to claim 14 wherein said first effective diameter is at least 0.01 inch larger than said second effective diameter.

16. The bottle according to claim 14 wherein said first effective diameter is not greater than 0.04 inch larger than said second effective diameter.

17. The bottle according to claim 14 wherein said first effective diameter is in the range of 0.01 inch to 0.04 inch larger than said second effective diameter.

18. The bottle according to claim 14 wherein said first effective diameter is in the range of 0.010 inch to 0.015 inch larger than said second effective diameter.
